(19) United States
(12) Patent Application Publication
(10) Pub. No.: US 2020/0124888 A1
(43) Pub. Date: Apr. 23, 2020

(54) LIQUID CRYSTAL PANEL

(71) Applicant: SHARP KABUSHIKI KAISHA, Sakai City (JP)

(72) Inventor: HIROAKI AKAMATSU, Sakai City (JP)

(21) Appl. No.: 16/655,904

(22) Filed: Oct. 17, 2019

Related U.S. Application Data
(60) Provisional application No. 62/749,560, filed on Oct. 23, 2018.

(51) Int. Cl. G02F 1/1339; G02F 1/1337; G02F 1/1362

(52) U.S. Cl. CPC G02F 1/1339; G02F 1/1362; G02F 1/1337

(57) ABSTRACT

A liquid crystal panel includes a first substrate including pixel electrodes and a common electrode overlapping the pixel electrodes, a second substrate opposed to the first substrate and including a light-blocking portion, a liquid crystal layer disposed between the first substrate and the second substrate, and a sealing member joining the first substrate and the second substrate together and surrounding the liquid crystal layer to seal the liquid crystal layer between the first substrate and the second substrate. The common electrode has a portion protruding outwardly from a display area of the liquid crystal panel and overlapping at least a portion of the light-blocking portion, and the sealing member is conductive and joins the first substrate and the second substrate together to allow the common electrode and the light-blocking portion to be electrically connected to each other.

### CROSS REFERENCE TO RELATED APPLICATION

This application claims priority from U.S. Provisional Patent Application No. 62/749,560 filed on Oct. 23, 2018. The entire contents of the priority application are incorporated herein by reference.

### TECHNICAL FIELD

The technology described herein relates to a liquid crystal panel.

### BACKGROUND ART

Japanese Unexamined Patent Application Publication No. H9-269504 describes a liquid crystal panel including first and second substrates, a liquid crystal layer between the first and second substrates, and a sealing member sealing the liquid crystal layer. In the liquid crystal panel, the first substrate (array substrate) has multiple pixel electrodes and a common electrode disposed over the multiple pixel electrodes. When the pixel electrode and the common electrode have difference in potential, a horizontal electric field (electric field along the surface of the substrate) is mainly generated between the pixel electrode and the common electrode. The alignment of the liquid crystal molecules contained in the liquid crystal layer is controlled by the horizontal electric field. Furthermore, in the liquid crystal panel, the black matrix included in the second substrate (counter substrate) is formed of a conductive material. The conductive black matrix is short-circuited to the common electrode of the array substrate. This allows the black matrix to function as the common electrode for the pixel electrodes of the array substrate and generates a vertical electric field, reducing a decrease in white level and reducing image sticking.

In the liquid crystal panel in which the alignment of the liquid crystal molecules is controlled by the horizontal electrical filed, the liquid crystal molecules may be improperly aligned at a position near the border between the light-blocking portion end the opening of the pixel, allowing light from the light source, such as a backlight device, to leak. This is probably because that the light-blocking portion of the second substrate (counter substrate) is charged due to a potential for driving the electrode of the first substrate (array substrate). A difference in potential between the charged light-blocking portion of the counter substrate and the electrode of the array substrate generates an electrical filed directed from one of the substrates to the other. In particular, the light-blocking portion is readily charged and light leakage readily occurs at the outer peripheral portion of the display area, because the counter substrate has the light-blocking portion disposed in a solid state with no opening at the outer peripheral portion and the array substrate has many lines for driving the electrodes at the outer peripheral portion. [0005] in the above liquid crystal panel, the black matrix (light-blocking portion) formed of a conductive material is short-circuited to the common electrode to eliminate the difference in potential between the light-blocking portion and the common electrode of the array substrate at the overlapping portion. This reduces the possibility that the light-blocking portion will be charged. However, the liquid crystal panel includes the conductive member other than the sealing member, increasing the number of necessary materials and the number of production steps. Furthermore, in the liquid crystal panel, the alignment film of the first substrate and the alignment film of the second substrate are attached to each other with a sealing member. This lowers the peel strength of the first and second substrates.

The technology described herein was made in view of the above-described circumstance and an object thereof is to provide a liquid crystal panel that has less light leakage and higher display quality by using a simple structure.

A liquid crystal panel according to the present technology includes a first substrate including pixel electrodes and a common electrode overlapping the pixel electrodes, a second substrate opposed to the first substrate and including a light-blocking portion configured to block light, a liquid crystal layer disposed between the first substrate and the second substrate, a sealing member joining the first substrate and the second substrate together and surrounding the liquid crystal layer to seal the liquid crystal layer between the first substrate and the second substrate. The common electrode has a portion protruding outwardly from a display area of the liquid crystal panel and overlapping at least a portion of the light-blocking portion. The sealing member is conductive and joins the first substrate and the second substrate together to allow the common electrode and the light-blocking portion to be electrically connected to each other.

The technology described herein provides a liquid crystal panel that has less light leakage and higher display quality by using a simple structure.

### BRIEF DESCRIPTION OF THE DRAWINGS

FIG. 1 is a plan view of a liquid crystal panel according to a first embodiment.

FIG. 2 is a plan view indicating a pixel arrangement of the liquid crystal panel in FIG. 1.

FIG. 3 is a cross-sectional view of the liquid crystal panel taken along line iii-m in FIG. 2.

FIG. A is a cross-sectional view of the liquid crystal panel illustrated in FIG. 2 and taken in the X axis direction (including a cross-sectional view taken along line IV-IV in FIG. 2).

FIG. 5 is a cross-sectional view of a liquid crystal panel according to a modification of the first embodiment taken in the X axis direction.

FIG. 6 is a plan view of a liquid crystal panel according to a second embodiment.

### DETAILED DESCRIPTION

Hereinafter, embodiments are described in detail as modes for carrying out the present technology with reference to the drawings. However, the present technology is not limited to the following embodiments. Various modifications and improvements may be made to the embodiments based on knowledge of those skilled in the art.

### First Embodiment

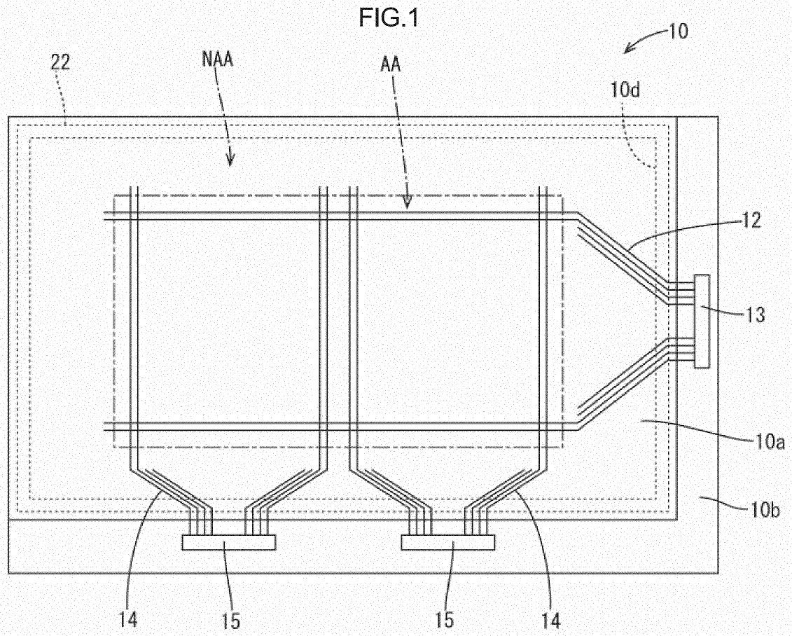

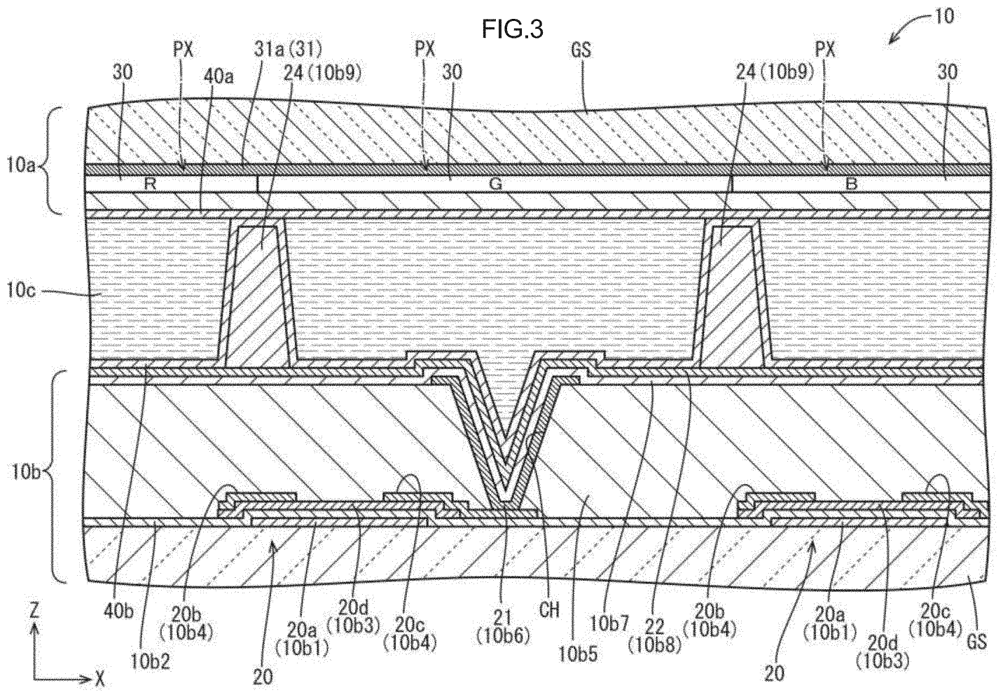

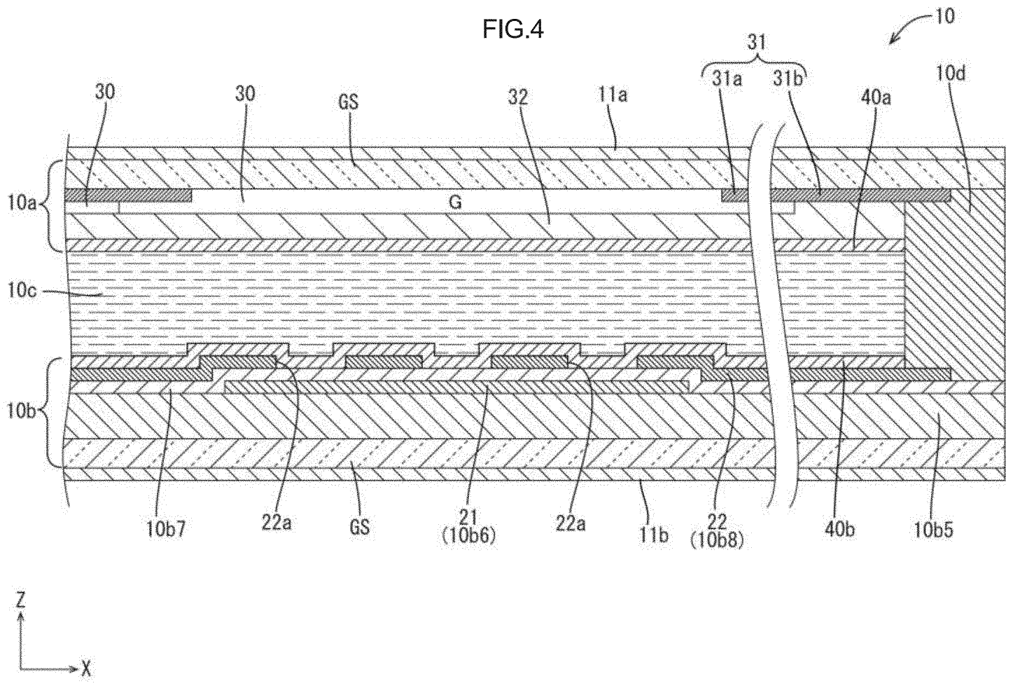

A liquid crystal panel 10 of a first embodiment is illustrated in FIGS. 1 to 4. The liquid crystal panel 10 has a horizontally long rectangular overall shape. The display surface of the liquid crystal panel 10 has a display area (active area) AA capable of displaying an image and a non-display area (non-active area) NAA uncapable of displaying an image. The non-display area NAA has a picture-frame-like shape (frame-like shape) and surrounds the display area AA. In FIG. 1, a one-dot chain line indicates an outline of the display area AA and the area outside the one-dot chain line is the non-display area NAA. The X axis, the Y axis, and the Z axis are indicated in some of the drawings, and each of the axes indicates the same direction in the respective drawings. The long-side direction of the liquid crystal panel 10 matches the X axis direction in the drawings and the short-side direction thereof matches the Y axis direction in the drawings. The vertical direction (front-rear direction) is based on FIGS. 3 and 4. In some cases, the upper side in FIGS. 3 and 4 is referred to as a front side and the lower side in FIGS. 3 and 4 is referred to as a rear side.

The liquid crystal panel 10 includes two substantially transparent opposing substrates 10a and 10b having high light-transmitting properties, a liquid crystal layer 10c (FIG. 4) located between the substrates 10a and 10b and containing liquid crystal molecules, which are substances whose optical properties are changed by application of an electric field, and a sealing member 10d joining the substrates 10a and 10b together with a cell gap corresponding to the thickness of the liquid crystal layer 10c therebetween. The sealing member 10d extends along the outer periphery of the CF substrate 10a and surrounds the liquid crystal layer 10c to seal the liquid crystal layer 10c between the substrates 10a and 10b. In FIG. 1, an inner broken line indicates an inner edge of the sealing member 10d. One on the rear side (rear surface side) of the two substrates 10a and 10b included in the liquid crystal panel 10 is an array substrate (TFT substrate, display substrate, active matrix substrate) 10b or a first substrate and the other on the front side is a CF substrate (counter substrate) 10a or a second substrate. The CF substrate 10a and the array substrate 10b each include a glass substrate GS and various films on the inner surface of the glass substrate GS. The substrates 10a and 10b have polarizing plates 11a and 11b (FIG. 4) on the outer surfaces. As illustrated in FIG. 1, the array substrate 10b is larger than the CF substrate 10a and has portions protruding from the CF substrate 10a. A gate driver 13 that supplies scanning signals to gate lines (scanning lines) 12 extending in the X axis direction is mounted on the protruding portion extending in the long-side direction (right portion in FIG. 1). Source drivers 15 that supply various signals to source lines (signal lines, data lines) 14 extending in the Y axis direction is mounted on the protruding portion extending in the short-side direction (lower portion in FIG. 1).

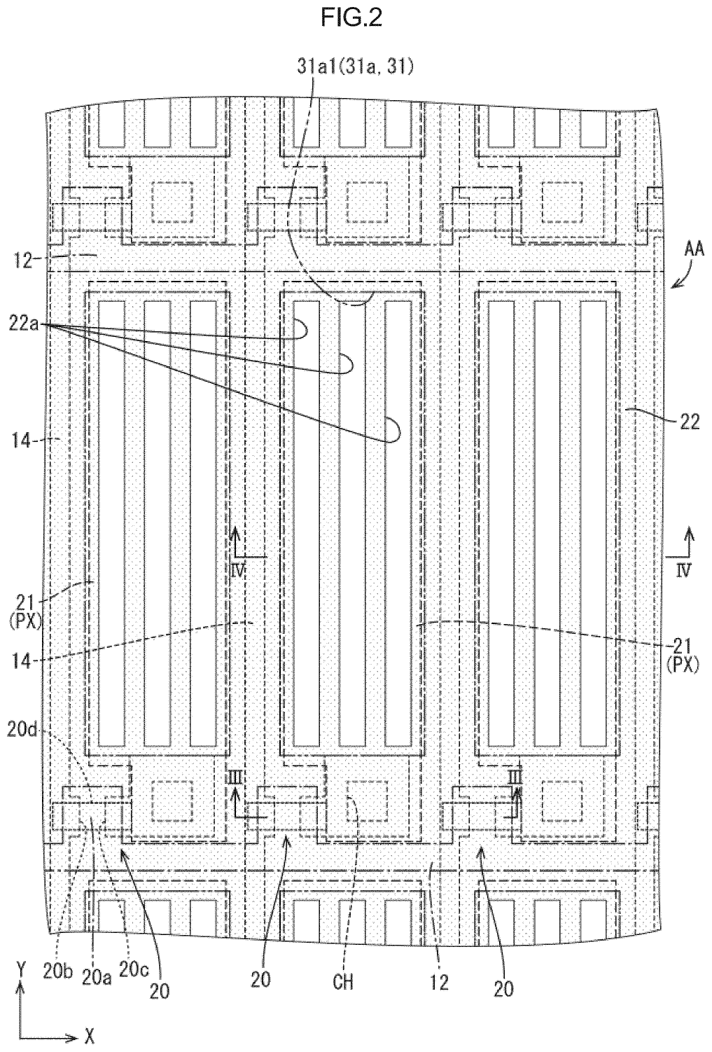

Next, the internal structure of the liquid crystal panel 10 is described. As illustrated in FIG. 2, the array substrate 10b includes TFTs (thin film transistors) 20, which are switching devices, and pixel electrodes 21 arranged in a matrix (rows and columns) in the X axis direction and the Y axis direction over the display area AA. The gate lines 12 and the source lines 14 are arranged in a grid pattern to surround the TFTs 20 and the pixel electrodes 21. The pixel electrode 21 is disposed in an area defined by the gate lines 12 and the source lines 14. The pixel electrode 21 has a vertically long (longitudinal) rectangular shape. The long-side direction of the pixel electrode 21 matches the Y axis direction and the short-side direction thereof matches the X axis direction.

As illustrated in FIGS. 2 and 3, the TFT 20 is adjacent in the Y axis direction to the pixel electrode 21 and connected to the pixel electrode 21. The gate electrode 20a of the TFT 20 branches from the gate line 12 and protrudes in the Y axis direction. The source electrode 20b of the TFT 20 is a portion of the source line 14 and is connected to a first end of the channel portion 20d. The drain electrode 20c of the TFT 20 is spaced apart from the source electrode 20b in the X axis direction and has a first end connected to a second end (away from the source electrode 20b) of the channel portion 20d and a second end connected to the pixel electrode 21. The channel portion 20d of the TFT 20 overlaps the gate electrode 20a. The channel portion 20d extends in the X axis direction and is connected to the source electrode 20b and the drain electrode 20c at the ends. When the TFT 20 is activated m response to a scanning signal supplied to the gate electrode 20a, the data signal (image signal, electric charge) supplied to the source line 14 is sent from the source electrode 20b to the drain electrode 20c through the channel portion 20d. Thus, the pixel electrode 21 is charged to a potential in accordance with the date signal.

As illustrated in FIGS. 2 to 4, the array substrate 10b includes a common electrode 22 disposed above the pixel electrodes 21 (side adjacent to the liquid crystal layer 10c) and overlapping all the pixel electrodes 21 over the display area AA. The common electrode 22 always has a substantially constant reference potential. The common electrode 22 extends at least over substantially the entire area of the display area AA, which will be described later in detail. The common electrode 22 has vertically long pixel overlapping openings (pixel overlapping slits, alignment control slits) 22a (three slits in this embodiment as illustrated in FIGS. 2 and 4) for each of the overlapping pixel electrodes 21. A potential difference is caused between the common electrode 22 and the overlapping pixel electrode 21 when the pixel electrode 21 is charged, generating a fringe electric field (oblique electric field) containing components normal to the plate surface of the array substrate 10b in addition to components (parallel electric field) parallel to the plate surface of the array substrate 10b between the edge of the pixel overlapping opening 22a and the pixel electrode 21. The alignment of the liquid crystal molecules contained in the liquid crystal layer 10c is controlled by using the fringe electric field. In other words, the liquid crystal panel 10 of this embodiment operates in a fringe field switching (FFS) mode.

As illustrated in FIG. 3, the CF substrate 10a includes color filters 30 including red (R), green (G), and blue (B) color filters over the display area AA. The color filters 30 having different colors are alternately and repeatedly arranged along the gate line 12 (X axis direction) and each extend along the source line 14 (substantially in the Y axis direction). Thus, the color filters 30 are arranged in a striped pattern. The color filters 30 overlap the pixel electrodes 21 of the array substrate 10b in plan view. The border (color border) between the color filters 30 of different colors adjacent to each other in the X axis direction overlap the source line 14 and a light-blocking portion 31, which will be described later. In the liquid crystal panel 10, the R, G, and B color filters 30 arranged in the X axis direction and three pixel electrodes 21 opposing the color filters 30 constitute the pixels PX of three colors.

As illustrated in FIGS. 2 to 4, the OF substrate 10a includes a black matrix 31, which is a light-blocking portion configured to block light. The black matrix 31 includes a pixel-to-pixel light-blocking portion 31a extending over the pixels PX in the display area AA and an outer peripheral light-blocking portion 31b (FIG. 4) located outside the display area AA. The pixel-to-pixel light-blocking portion 31a has a grid-like shape in a plan view and separates the pixels PX (pixel electrodes 21) adjacent to each other. The pixel-to-pixel light-blocking portion 31a has pixel openings 31a1, through which light passes, at positions overlapping a large portion of the pixel electrodes 21 of the array substrate 10b in plan view. The pixel openings 31a1 are arranged in the CF substrate 10a in a matrix in the X axis direction and the Y axis direction as the pixel electrodes 21. The pixel-to-pixel light-blocking portion 31a overlaps the gate lines 12 and the source lines 14 of the array substrate 10b in plan view. The outer peripheral light-blocking portion 31b will be described in detail later. The CF substrate 10a has an overcoat film 32 on the color filter 30 such that the CF substrate 10a has a flat inner surface.

As illustrated in FIG. 3, spacers 24 are disposed between the substrates 10a and 10b in the display area AA such that the liquid crystal layer 10c keeps a constant thickness (cell gap, distance). The spacer 24 extends upward from the common electrode 22 of the array substrate 10b to the color filter 30 of the CF substrate 10a through the liquid crystal layer 10c. The spacers 24 are located at the color borders between the color filters 30. Furthermore, alignment films 40a and 40b for aligning liquid crystal molecules in the liquid crystal layer 10c are disposed on innermost surfaces of the substrates 10a and 10b adjacent to the liquid crystal layer 10c. The alignment films 40a and 40b are each formed of, for example, polyimide and disposed in a solid form over substantially the entire area of the display area AA of the substrates 10a and 10b.

Here, films included in the array substrate 10b are described. As illustrated in FIG. 3, the array substrate 10b having a glass substrate GS includes, in this order from the lower side (adjacent to the glass substrate GS), a first metal film (gate metal film, conductive film) 10b1, a gate insulating film 10b2, a semiconductor film 10b3, a second metal film (source metal film, conductive film) 10b4, a flattening film (insulating film, organic insulating film) 10b5, a first transparent electrode film (conductive film) 10b6, an interlayer insulating film (insulating film, inorganic insulating film) 10b7, a second transparent electrode film (conductive film) 10b8, and an organic insulating film 10b9. In FIG. 4, the films on the lower side of the flattening film 10b5 are not illustrated.

The first metal film 10b1 and the second metal film 10b4 each may be a single-layer film formed of a metal material, such as Al, Cu, Ti, and Mo, or a multi-layer film or an alloy film formed of different kinds of metal materials and thus has conductivity and light-blocking properties. The first and second metal films 10b1 and 10b4 each extend over both the display area AA and the non-display area NAA. The first metal film 10b1 constitutes the gate lines 12 and the gate electrodes 20a of the TFTs 20. The second metal film 10b4 constitutes the source lines 14 and the source electrodes 20b and the drain electrodes 20c of the TFTs 20. The gate insulating film 10b2 and the interlayer insulating film 10b7 are each formed of an inorganic material, such as silicon nitride (SiN_{X}) and silicon dioxide (SiO₂), to insulate the upper second metal film 10b4 from the lower first metal film 10b1 and to insulate the upper second transparent electrode film 10b8 from the lower first transparent electrode film 10b6. The insulating films 10b2 and 10b7 formed of an inorganic material each extend over both the display area AA and the non-display area NAA. The insulating films 10b2 and 10b7 formed of an inorganic material is thinner than the flattening film 10b5 and the organic insulating film 10b9, which will be described later. The flattening film 10b5 and the organic insulating film 10b9 are formed of an organic material, such as an acrylic resin (for example, PMMA). The flattening film 10b5 is used to eliminate difference in level on the lower side. The organic insulating film 10b9 constitutes the spacers 24, for example. The semiconductor film 10b3 includes a thin film formed of an amorphous silicon or an oxide semiconductor, for example, and constitutes the channel portions (semiconductor portions) 20d of the TFTs 20 connected to the source electrodes 20b and the drain electrodes 20c, for example. The first transparent electrode film 10b6 and the second transparent electrode film 10b8 are formed of a transparent electrode material, such as indium tin oxide (ITO) and indium zinc oxide (IZO) and each extend over both the display area AA and the non-display area NAA. The first transparent electrode film 10b6 constitutes the pixel electrodes 21, for example, and the second transparent electrode film 10b8 constitutes the common electrode 22, for example.

The flattening film 10b5 has contact holes CH through which the pixel electrodes 21 formed of the first transparent electrode film 10b6 are connected to the drain electrodes 20c formed of the second metal fil 10b4. The contact holes CH overlap both the pixel electrodes 21 and the drain electrodes 20c in plan view.

A liquid crystal panel in which the alignment of the liquid crystal molecules is controlled by using the horizontal electric field as the liquid crystal panel 10 of the embodiment may have a liquid crystal molecule alignment defect at a position around the border between the black matrix 31 and the pixel opening 31a1, leading to light leakage from the light source such as a backlight device. This is probably because that the black matrix 31 of the CF substrate 10a is charged due to the electric potential for driving the electrodes of the array substrate 10b and an electric field directed from the array substrate 10b to the CF substrate 10a (vertical direction) is generated by difference in potential between the black matrix 31 of the CF substrate 10a and the electrodes and the lines of the array substrate 10b. In particular, the outer peripheral light-blocking portion 31b is readily charged and readily allows light to leak to the display area AA, because the outer peripheral light-blocking portion 31b is disposed in a solid form with no opening in the CF substrate 10a and the array substrate 10b has many lines 12 and 14 for driving the electrodes.

The liquid crystal panel 10 of the embodiment has overcome the above-described problems and has less light leakage and higher display quality. Specifically described, as illustrated in FIGS. 1 to 4, the common electrode 22 of the array substrate 10b extends across the display area AA to a position outside the display area AA and overlaps the sealing member 10d. Then, the alignment film 40b disposed above the common electrode 22 has the outer edge positioned inwardly from the outer edge of the common electrode 22. In other words, the outer peripheral portion of the array substrate 10b has the common electrode 22 as the top layer. In contrast, as illustrated in FIG. 4, the outer peripheral light-blocking portion 31b of the black matrix 31 of the CF substrate 10a extends outwardly and overlaps the sealing member 10d. The overcoat film 32 and the alignment film 40a on the black matrix 31 each have an outer edge positioned inwardly from the outer edge of the black matrix 31. In other words, the outer peripheral portion of the CF substrate 10a has the black matrix 31 as the top layer. In the liquid crystal panel 10 having such a configuration, the black matrix 31 overlaps the common electrode 22 not only at the pixel-to-pixel light-blocking portion 31a but also at the outer peripheral light-blocking portion 31b.

The sealing member 10d is in contact with the common electrode 22 of the array substrate 10b at the lower end surface and in contact with the black matrix 31 of the CF substrate 10a at the upper end surface such that the substrates 10a and 10b are attached to each other through the sealing member 10d. The sealing member 10d is formed of a sealing material including conductive particles and thus has conductivity. In other words, the sealing member 10d allows electrical connection between the common electrode 22 of the array substrate 10b and the black matrix 31 of the CF substrate 10a. Thus, in the liquid crystal panel 10, the potential of the black matrix 31 is the same as that of the common electrode 22, because the common electrode 22 and the black matrix 31 are connected to each other through the conductive sealing member 10d. Furthermore, the black matrix 31 and the common electrode 22 have no difference in potential, because the black matrix 31 overlaps the common electrode 22 as described above, reducing the possibility that a vertical electric field will be generated between the black matrix 31 and the common electrode 22. In other words, the liquid crystal panel 10 has less light leakage from the black matrix 31, specifically, less light leakage from the pixel-to-pixel light-blocking portion 31a to the pixel PX and less light leakage from the outer peripheral light-blocking portion 31b to the display area AA, and thus has higher display quality. The alignment films 40a and 40b extend to the inner edge of the sealing member 10d and the sealing member 10d is not attached to the alignment films 40a and 40b, and thus the peel strength is not lowered.

In general, if the black matrix 31 has high conductivity, an electric field would be generated between the substrates 10a and 10b, affecting the alignment of the liquid crystal molecules. Thus, the black matrix 31 preferably has low conductivity. In the liquid crystal panel having the above-described configuration in which the black matrix 31 has the same potential as the common electrode 22, the conductive level of the black matrix 31 has no influence. The black matrix 31 of the liquid crystal panel 10 may be conductive or nonconductive.

As illustrated in FIG. 1, in the liquid crystal panel 10, the common electrode 22 and the black matrix 31 are in contact with the sealing member 10d at the outer peripheral portion over the entire perimeter. In the liquid crystal panel 10 having such a configuration, the potential of the black matrix 31 is stably maintained at the potential of the common electrode 22. Furthermore, in the liquid crystal panel 10, the common electrode 22 has a portion extending all over the area between the outer edge of the display area AA and the sealing member 10d. In the liquid crystal panel 10 having such a configuration, the black matrix 31 and the common electrode 22 are opposed to each other over the entire area outside the display area AA, efficiently reducing the possibility that the black matrix 31 will be charged due to the electric potential of the array substrate 10b.

<Modifications>

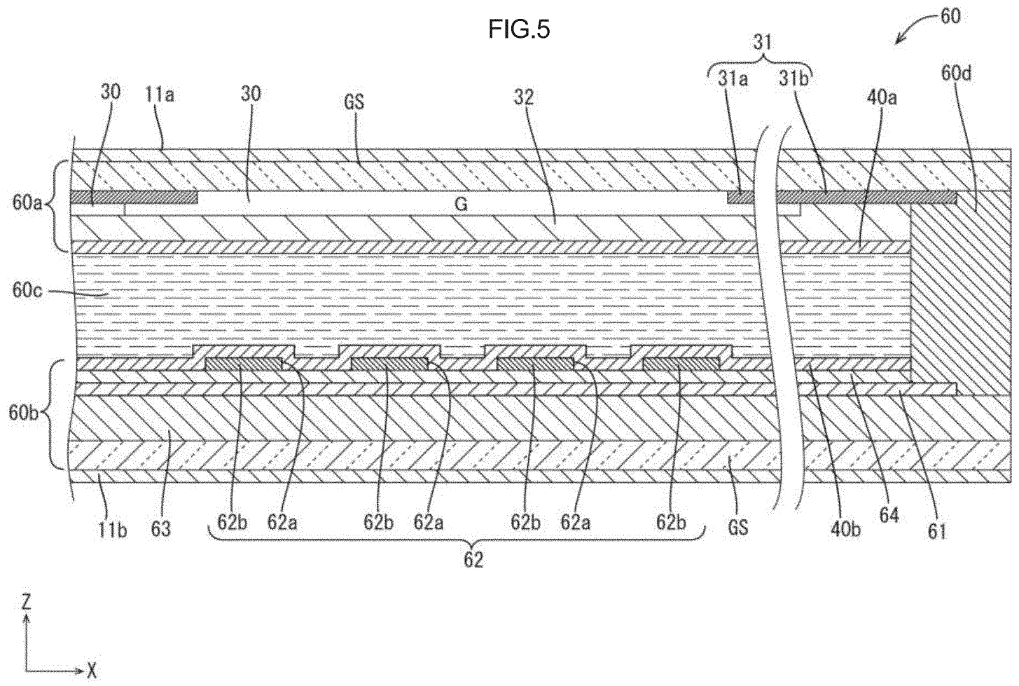

A liquid crystal panel 60 according to a modification of the first embodiment is illustrated in cross-section in FIG. 5 (cross-sectional view taken in the X axis direction). The liquid crystal panel 60 of the modification includes an array substrate having a configuration different from that of the liquid crystal panel 10 in the first embodiment. Thus, the array substrate 60b of the liquid crystal panel 60 in the modification is described in detail. The CF substrate 60a included in the modification has the same configuration as the CF substrate 10a in the first embodiment. The same reference numerals are assigned to the same components of the CF substrate 60a and the array substrate 60b as those in the liquid crystal panel 10 of the first embodiment without duplicated explanation.

Although the array substrate 10b in the first embodiment includes the common electrode 22 disposed above the pixel electrodes 21, the array substrate 60b in the modification includes a common electrode 61 disposed below pixel electrodes 62. Specifically described, although the layers including the TFTs 20 and the lines 12 and 14 are the same as those in the first embodiment, the position of the common electrode 61 is different. The common electrode 61 is disposed in a solid form on the upper side of a flattening film 63 and extends across the display area AA to a position outside the display area AA. The inter-layer insulating film 64, the pixel electrode 62, the organic insulating film (spacer), and the alignment film 40b are disposed in this order on the upper side of the common electrode 61.

The pixel electrode 62 has slits 62a (three slits 62a in FIG. 5) extending in the long-side direction of the pixel electrode 62 (Y axis direction). In other words, the pixel electrode 62 is divided by the three slits 62a into three divided electrodes 62b. The divided electrodes 62b and the slits 62a are alternately arranged in the X axis direction (short-side direction of the pixel electrode 62). In other words, a potential difference is caused between the common electrode 61 and the overlapping pixel electrode 62 when the pixel electrode 62 is charged, generating mainly a horizontal electric field between the edge of the slit 62a of the pixel electrode 62 and the common electrode 61. The alignment of the liquid crystal molecules contained in the liquid crystal layer 60c is controlled by the horizontal electric field. The liquid crystal panel 60 of this modification operates in an FFS mode as the liquid crystal panel 10 of the first embodiment.

As in the first embodiment, the common electrode 61 of the array substrate 60b in the modification protrudes outwardly and overlaps the sealing member 60d. Furthermore, the inter-layer insulating film 64 and the alignment film 40b disposed above the common electrode 61 extending outwardly to the non-display area NAA each have an outer edge positioned inwardly from the outer edge of the common electrode 61. In other words, the array substrate 60b has the common electrode 61 as the top layer at the outer peripheral portion and the common electrode 61 is in contact with the conductive sealing member 60d. Thus, the liquid crystal panel 60 in the modification has less light leakage from the black matrix 31 and has high display quality as that in the first embodiment.

### Second Embodiment

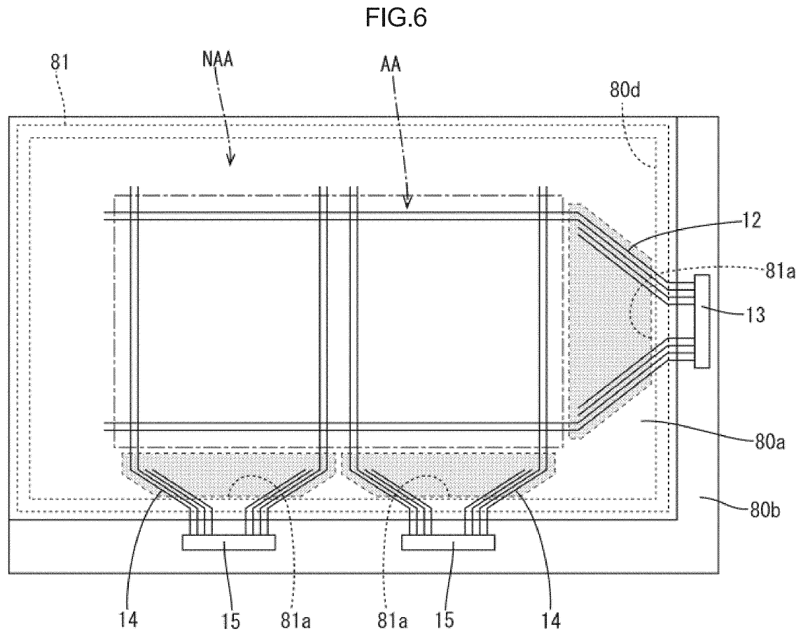

A liquid crystal panel 80 according to a second embodiment is illustrated in FIG. 6. The liquid crystal panel 80 of the second embodiment has a configuration similar to that of the liquid crystal panel 10 of the first embodiment. Thus, the same reference numerals are assigned to the same components as those in the liquid crystal panel 10 of the first embodiment without duplicated explanation.

The liquid crystal panel 80 of the second embodiment has a CF substrate 80a having the same configuration as that of the CF substrate 10a of the liquid crystal panel 10 of the first embodiment. However, the array substrate 80b of the liquid crystal panel 80 has a configuration different from the array substrate 10b in the first embodiment. Specifically described, in the array substrate 10b in the first embodiment, the portion of the common electrode 22 outside the display area AA is disposed in a solid form. However, in the array substrate 80b in the second embodiment, the common electrode 81 has multiple openings 81a in the non-display area NAA. The openings 81a are located in the non-display area NAA at positions where the gate lines 12 extending from the gate driver 13 and the source lines 14 extending from the source driver 15 (hatched areas in FIG. 6) exist. [0039] in the liquid crystal panel 80 of the second embodiment, the common electrode 81 is not located over the lines 12 and 14 in an area between the outer edge of the display area AA and the inner edge of the sealing member 80d, i.e., the common electrode 83 does not overlap the lines 12 and 14. In the liquid crystal panel 80 of the second embodiment, coupling between the lines 12 and 14 and the common electrode 81 does not occur and light leakage through the black matrix 31 less likely to occur.

1. A liquid crystal panel, comprising:
a first substrate including a plurality of pixel electrodes and a common electrode overlapping the plurality of pixel electrodes;
a second substrate opposed to the first substrate and including a light-blocking portion configured to block light;
a liquid crystal layer disposed between the first substrate and the second substrate; and
a sealing member joining the first substrate and the second substrate together and surrounding the liquid crystal layer to seal the liquid crystal layer between the first substrate and the second substrate, wherein
the common electrode has a portion protruding outwardly from a display area of the liquid crystal panel and overlapping at least a portion of the light-blocking portion, and
the sealing member is conductive and joins the first substrate and the second substrate together to allow the common electrode and the light-blocking portion to be electrically connected to each other.

2. The liquid crystal panel, according to claim 1, wherein each of the common electrode and the light-blocking portion is in contact with the sealing member at an outer peripheral portion over an entire perimeter thereof.

3. The liquid crystal panel, according to claim 1, wherein the common electrode has a portion extending all over an area between an outer edge of the display area and the sealing member.

4. The liquid crystal panel according to claim 1, wherein
the first substrate includes lines for driving the plurality of pixel electrodes, and
the common electrode is not disposed over an area extending from an outer edge of the display area to an inner edge of the sealing member and overlapping the lines.

5. The liquid crystal panel according to claim 1, wherein
the common electrode is located closer to the liquid crystal layer than the plurality of pixel electrodes and the first substrate includes an alignment film located on a side of the common electrode adjacent to the liquid crystal layer and configured to align liquid crystal molecules, and
the common electrode has a portion protruding outwardly from the alignment film and is connected to the sealing member at the portion.

6. The liquid crystal panel according to claim 1, wherein
the plurality of pixel electrodes are located closer to the liquid crystal layer than the common electrode, and the first substrate includes an insulating film and an alignment film, and the insulating film is disposed between the plurality of pixel electrodes and the common electrode and the alignment film is disposed on a side of the plurality of pixel electrodes adjacent to the liquid crystal layer and configured to align the liquid crystal molecules, and
the common electrode has a portion protruding outwardly from the insulating film and the alignment film and is connected to the sealing member at the portion.

7. The liquid crystal panel according to claim 1, wherein
the second substrate includes an alignment film located closest to the liquid crystal layer and configured to align the liquid crystal molecules, and
the light-blocking portion has a portion protruding outwardly from the alignment film and is connected to the sealing member at the portion.
